(19) United States
(12) Patent Application Publication
(10) Pub. No.: US 2004/0169005 A1
(43) Pub. Date: Sep. 2, 2004

(54) Methods for forming a thin film on an integrated circuit including soft baking a silicon glass film

(76) Inventors: Hong-Gun Kim, Gyeonggi-do (KR); Eun-Kee Hong, Gyeonggi-do (KR); Ju-Seon Goo, Gyeonggi-do (KR)

Correspondence Address: MYERS BIGEL SIBLEY & SAJOVEC, PO BOX 37428, RALEIGH, NC, 27627, US

(21) Appl. No.: 10/722,319

(22) Filed: Nov. 24, 2003

(30) Foreign Application Priority Data
Feb. 17, 2003 (KR) 2003-9917

(51) Int. Cl. H01B 13/00

(52) U.S. Cl. 216/13

(57) ABSTRACT

Methods of forming a thin film on an integrated circuit substrate including a stepped portion are provided. A spin on glass (SOG) film is formed on the substrate including the stepped portion to fill a recess defined by the stepped portion. The SOG film is soft baked at a temperature of less than 400° C. The soft baked SOG film is etched and an insulation film is formed on the etched SOG film. Methods of forming a trench isolation film including soft baking an SOG film are also provided.

### RELATED APPLICATION

This application claims priority to Korean Patent Application 2003-9917, filed on Feb. 17, 2003, the contents of which are herein incorporated by reference in their entirety.

### BACKGROUND OF THE INVENTION

The present invention relates to methods for forming a thin film on an integrated circuit substrate, and more particularly, to methods of forming such films for use as a trench isolation film.

It is known to use an isolation region between active regions of an integrated circuit (semiconductor) device. For example, the local oxidation of silicon (LOCOS) method is widely used as an isolation method for integrated circuit devices. However, the LOCOS method may have some disadvantages as a feature known as a bird's beak may be caused by a lateral oxidation of an isolation film. In addition, a crystalline defect of a substrate may be caused by a stress of a buffer layer generated during a thermal process. Furthermore, a re-distribution of impurities implanted to block a channel of the integrated circuit device may occur. Therefore, the LOCOS method may not always be suitable for integrated circuit devices having a high integration density and/or an improved electrical characteristic.

It has been proposed to use a shallow trench isolation (STI) method to address various of these problems of the LOCOS method. Typically, in the STI process, after a trench is formed on a substrate by partially etching the substrate, an insulation film is formed on the substrate to fill up the trench so that an isolation film is formed in the trench. The STI method may avoid some of the problems caused by a thermal oxidation process because the STI method generally does not employ the thermal oxidation process used in the LOCOS method. Furthermore, the STI method can remove the bird's beak caused by the local oxidation as the STI method generally does not utilize the local oxidation process used in the LOCOS method. In addition, a depth of the trench typically can be readily adjusted using the STI method. For a highly integrated dynamic random access memory (DRAM) device having an isolation film with a width of less than about 0.2 μm, the isolation film (referred to as a trench isolation film) typically can be formed using the STI method.

The STI method generally includes process steps for forming a trench having a predetermined depth by etching a substrate, for forming an insulation film on the substrate to fill up the trench and for removing portions of the insulation film to form an isolation film in the trench. The insulation film generally includes an oxide film that may be formed using a plasma enhanced chemical vapor deposition (PECVD) process. However, in such a case, when the oxide film is employed to fill up the trench, the trench may not be sufficiently filled up with the oxide. In other words, the oxide film may not completely fill up the trench and a defect, such as a void, may occur in the oxide, particularly when the trench has a high aspect ratio.

As a further alternative approach, a spin on glass (SOG) film may be employed for filling the trench because the SOG film typically has a good gap filling capacity. However, because the SOG film is generally not hard when compared with the oxide film, the SOG film may be damaged and, thereby, may cause processing failures during successive process, such as an etching process and a chemical mechanical polishing (CMP) process, after the SOG film is formed in the trench. To address this potential problem, it has been proposed to form a trench isolation film in which a hard insulation film is formed on an SOG film after forming the SOG film in a trench. Examples of such a method are disclosed in Korean Patent No. 165,462, Korean Patent Laid Open Publication No. 2001-4258 and Japanese Patent Laid Open Publication No. 2000-114362.

As described in Korean Patent No. 165,462, after a first insulation film including hydrogen silsesquioxane is formed on a substrate having a trench, the first insulation film is baked at a temperature of more than about 500° C. After heat treating, the first insulation film is etched and a second insulation film is formed on a portion of the first insulation film in the trench.

As described in Korean Patent Laid Open Publication No. 2001-4258, after an SOG film is partially buried in a trench formed on a substrate, the SOG film is cured. An insulation film is formed on the SOG film in the trench. As described in Japanese Patent Laid Open Publication No. 2000-114362, an SOG film is partially buried in a trench formed on a substrate and the SOG film is baked at a temperature of more than about 400° C. An insulation film is formed on the SOG film in the trench.

For the above-described methods, a trench isolation film is formed by methods including curing or baking the SOG film after the SOG film is formed in the trench. However, when the SOG film is cured or baked at a temperature of more than about 400° C., the SOG film is generally easily oxidized so that an etching rate of the SOG film may be changed during a successive etching process.

FIG. 1 is a graph illustrating variations of a reflection index and a thickness of an SOG film relative to a delay time according to the conventional method for forming a trench isolation film. In FIG. 1, the SOG film is hard baked at a temperature of about 400° C. The delay time as used herein refers to a time for maintaining the hard baked SOG film at an air. That is, the SOG film is maintained under an atmosphere for the delay time after a hard baking process is performed about the SOG film.

As shown in FIG. 1, a reflection index (RI) of the SOG film decreases with increased delay time while a thickness (THK) of the SOG film increases. Thus, when the SOG film is hard baked at a temperature of about 400° C., the SOG film may be unstable so that, for example, the SOG film may be oxidized as a result of being reacted with oxygen gas or moisture in the air.

FIG. 2 is a graph illustrating a variation of an etching rate of the SOG film relative to the delay time according to the conventional method. As shown in FIG. 2, like FIG. 1, the SOG film is hard baked at a temperature of about 400° C.

When the baked SOG film is etched using an etching solution including hydrogen fluoride (HF) that is diluted with deionized water by a volume ratio of about 1:200, the etching rate of the SOG film is rapidly reduced up to a delay time of about 50 hours. In other words, when the SOG film is hard baked at a temperature of about 400° C., the etching rate of the SOG film varies with the delay time. As a result, the SOG film may not have a predetermined uniformity during an etching process after the SOG film is hard baked at a temperature of about 400° C. In addition, an insulation film formed on a non-uniformly etched SOG film may have a void formed therein when the insulation film is formed on the SOG film. As a result, the resulting SOG film may not be suitable for a trench isolation film even though the SOG film generally has a good gap filling capacity.

An insulation film, like an SOG film, can be formed on a substrate including a stepped portion, such as a gate electrode or a metal wiring pattern adjacent the trench. In particular, an SOG film and an additional insulation film can be successively formed as an interlayer dielectric (ILD) of an integrated circuit device. In such a case, the SOG film may sufficiently fill up a recess caused by the stepped portion so that an ILD having an even surface can be formed on the integrated circuit substrate. However, such an ILD including the SOG film and the insulation film, in practice, may not be easily formed on the substrate in light of the above-mentioned disadvantages of the SOG film.

### SUMMARY OF THE INVENTION

In some embodiments of the present invention, methods of forming a thin film on an integrated circuit substrate including a stepped portion are provided. A spin on glass (SOG) film is formed on the substrate including the stepped portion to fill a recess defined by the stepped portion. The SOG film is soft baked at a temperature of less than 400° C. The soft baked SOG film is etched and an insulation film is formed on the etched SOG film.

In other embodiments of the present invention, the SOG film is formed using a SOG solution including polysilazane. Etching the soft baked SOG film may be followed by thermally treating the SOG film at a temperature from about 400° C. to about 1200° C. to convert the etched SOG film to silicon oxide. The thermal treatment may be performed before forming an insulation film on the etched SOG film.

In further embodiments of the present invention, the soft baked SOG film is etched to a height lower than the recess defined by the stepped portion and the insulation film is formed on the etched SOG film to a height greater than the recess defined by the stepped portion. The SOG film may be etched to expose a surface of the stepped portion and the insulation film may also be formed on the exposed surface of the stepped portion. Soft baking the SOG film may be performed at a temperature of about 100° C. to about 300° C. The SOG film may be wet etched using a hydrogen fluoride (HF) solution. The insulation film may include oxide and the insulation film may be formed using a chemical vapor deposition (CVD) process.

In other embodiments of the present invention, etching the soft baked SOG film is followed by thermally treating the substrate. The stepped portion may include a plurality of gate electrodes and metal wiring patterns and/or trenches formed on the substrate. The method may further include planarizing the formed insulation film using a chemical mechanical polishing (CMP) process.

In further embodiments of the present invention, methods of forming a trench isolation film including forming a thin film according to one of the methods described above are provided. For such embodiments, the stepped portion is a trench on the substrate and the method further includes removing the formed insulation film to expose the substrate adjacent the trench.

In other embodiments of the present invention, methods of forming a trench isolation film on an integrated circuit substrate are provided. A trench is formed on the substrate using a deposited pattern as an etching mask. A spin on glass (SOG) film is formed on the substrate including the formed trench to fill the trench. The SOG film is soft baked at a temperature of less than 400° C. The soft baked SOG film is etched. An insulation film is formed on the etched SOG film. A portion of the formed insulation film is removed to expose the pattern and the exposed pattern is removed. A remaining portion of the insulation film is planarized. Forming the SOG film may be preceded by forming a liner on a surface of the substrate, a sidewall of the trench and/or a bottom face of the trench.

In further embodiments of the present invention, methods for forming a thin film include forming a spin on glass (SOG) film on a substrate including a stepped portion by coating an SOG solution on the stepped portion and on the substrate. Here, the SOG film sufficiently fills up a recess formed by the stepped portion and the stepped portion includes at least two gate electrodes, at least two metal wiring patterns or trenches formed on the substrate. After the SOG film is soft-baked, the SOG film is etched. Then, an insulation film is formed on a resultant structure formed on the substrate. In this case, the SOG film can be soft-baked at a temperature of about 100° C. to about 300° C., and the SOG film can be etched by a wet etching process using a hydrogen fluoride (HF) solution. Additionally, the insulation film includes oxide and the insulation film is formed using a chemical vapor deposition (CVD) process. Meanwhile, the substrate including the resultant structure can be thermally treated at a temperature of about 400° C. to about 1,200° C. and the insulation film can be planarized using a chemical mechanical polishing (CMP) process.

In other embodiments of the present invention, methods for forming a trench isolation film include, after a trench is formed on a substrate by etching the substrate using a pad oxide film pattern and a hard mask pattern as etching masks, forming an SOG film on a substrate to fill up the trench sufficiently by coating an SOG solution on the substrate including the trench. Subsequently, the SOG film is soft-baked, and the SOG film is etched. After an insulation film is formed on a resultant structure formed on the substrate, the insulation film is partially removed to expose the hard mask pattern. Then, the hard mask pattern and the pad oxide film pattern are removed, and the insulation film remaining on a surface of substrate is removed to expose the surface of the substrate. In this case, the insulation film can be removed using a CMP process and a liner including an insulation material can be continuously formed on the surface of the substrate, on a sidewall of the trench and/or on a bottom face of the trench.

### BRIEF DESCRIPTION OF THE DRAWINGS

FIG. 1 is a graph illustrating a reflection index and a thickness of a SOG film relative to a delay time according to a conventional method for forming a trench isolation film;

FIG. 2 is a graph illustrating an etching rate of the SOG film relative to the delay time according to the conventional method for forming a trench isolation film;

FIGS. 3A to 3D are schematic cross-sectional views illustrating methods for forming a thin film according to some embodiments of the present invention;

FIG. 4 is a graph illustrating a reflection index and a thickness of an SOG film relative to a delay time according to some embodiments of the present invention; and

FIGS. 5A to 5H are schematic cross-sectional views illustrating methods for forming a trench isolation film according to some embodiments of the present invention.

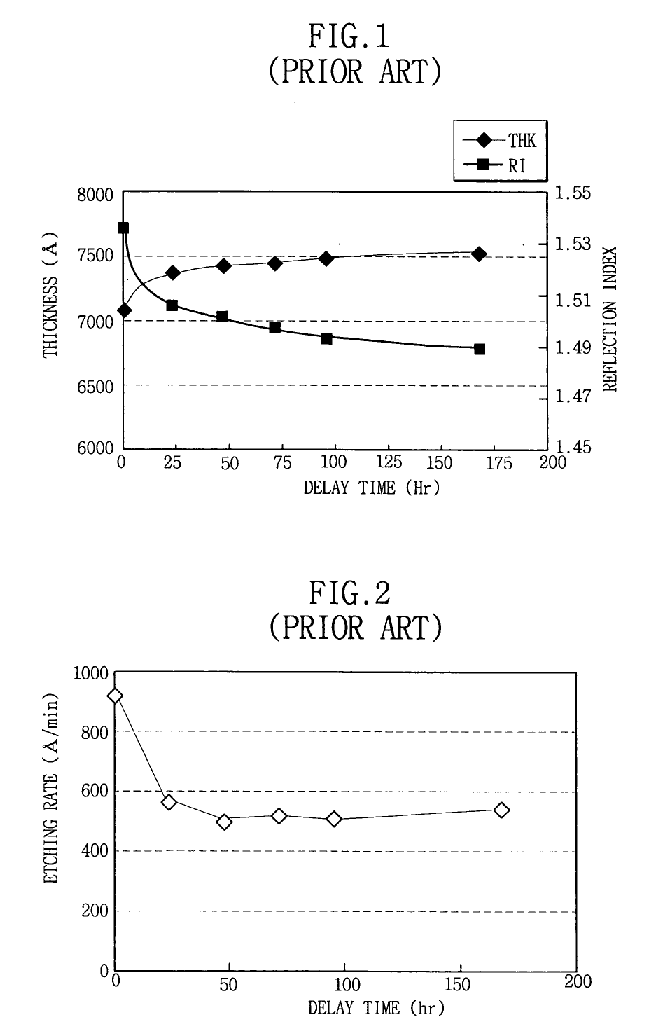

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. It will be understood that when an element is referred to as being “on” another element, it can be directly on the other element or intervening layers or elements may also be present. In contrast, when an element is referred to as being “directly on” another element, there are no intervening layers or elements present. The relative thickness of layers in the illustrations may be exaggerated for purposes of describing the present invention.

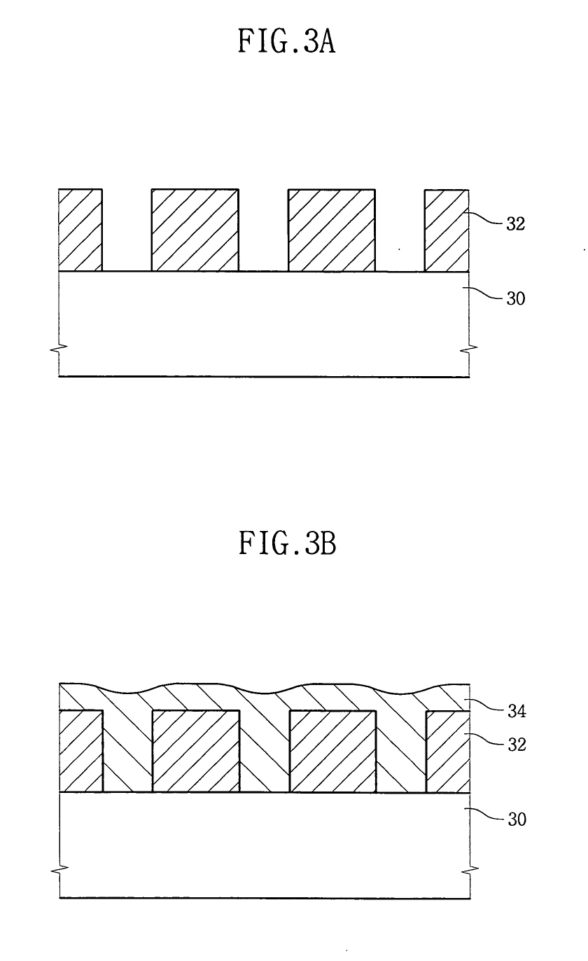

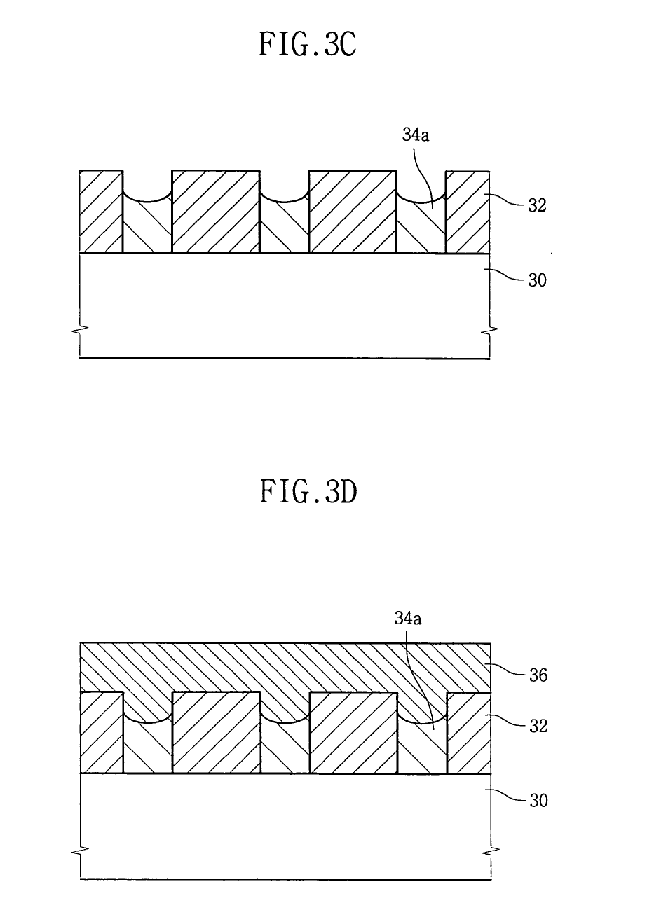

The present invention will now be further described with reference to the embodiments illustrated in the figures. FIGS. 3A to 3D are schematic cross-sectional views illustrating methods for forming a thin film according to some embodiments of the present invention.

As shown in FIG. 3A, an integrated circuit (semiconductor) substrate 30 includes a stepped portion 32 formed thereon. For example, the stepped portion 32 may include a gate electrode pattern, a metal wiring pattern, like a bit line, and/or a trench. For purposes of describing the present invention, a plurality of stepped portions 32 are illustrated as being formed on the substrate 30. As shown in FIG. 3A, a recess is generated between ones of the stepped portions 32.

Referring now to FIG. 3B, a spin on glass (SOG) solution, such as an SOG solution including polysilazane, is coated on the substrate 30 in the region having the stepped portions 32 to form an SOG film 34 on the substrate 30. The SOG film 34 covers the stepped portions 32 and fills up the recess between the stepped portions 32. As shown in FIG. 3B, the SOG film 34 fills the recess between the stepped portions 32 without void defects. The SOG film 34 may be formed using a spin coating process.

The formed SOG film 34 is treated using a soft-baking process. The soft-baking process is performed at a temperature of less than about 400° C. When the soft-baking process is performed at a temperature of lower than about 150° C., the SOG film 34 may not be easily hardened. Furthermore, a reflection index and a thickness of the SOG film 34 may vary with delay time when the soft-baking process is executed at a temperature of higher than about 300° C. For some embodiments of the present invention, the soft-baking process is performed at a temperature of about 150° C. to about 300° C. As such, the SOG film 34 may be advantageously heated at a temperature of about 150° C. to about 300° C. with no thermal treatment other than the soft-baking process.

As shown in FIG. 3C, the entire surface of the SOG film 34 in the region of the stepped portions 32 is etched. As a result, portions of the SOG film 34 on the upper surface of the stepped portions 32 are removed while portions of the SOG film 34a remain to fill up the recesses between the stepped portions 32. In particular, as illustrated for the embodiment in FIG. 3C, the SOG film 34 is over-etched during the etching process so that the portions of the SOG film 34a only partially fill up the recesses. In other words, the portions of the SOG film 34a in the recesses have heights lower than those of the recesses. The SOG film 34 may be etched, for example, using a wet etching process and/or a dry etching process.

For the wet etching process, the SOG film 34 may be etched using a hydrogen fluoride (HF) solution as an etching solution. The HF solution may be diluted by deionized water so that a volume ratio between the HF and the deionized water is, for example, about 1:200. As a result, the stepped portions 32 may not be damaged by the etching solution when the stepped portions 32 are exposed during the wet etching process. For the dry etching process, the SOG film 34 may be etched using a carbon-fluoride (C—F) based gas as an etching gas. For example, the C—F based gas may include C₅F₈, C₄F₈, C₄F₆, or CH₂F₂. Using the C—F based gas as the etching gas for etching the SOG film 34, damage to the stepped portions 32 may be limited or prevented during the dry etching process.

As the SOG film 34a is etched for a long enough time, the portions of the SOG film 34a are buried in the recesses to have heights lower than those of the recesses. In other words, the heights of the portions of the SOG film 34a remaining in the recesses are relatively lower than heights of the stepped portions 32 formed on the substrate 30. As the SOG film 34 generally has a good gap filling capacity, the portion of the SOG film 34a can substantially completely fill up the lower portion of the recesses even when the recesses have a high aspect ratio (i.e., when an interval (gap) between the stepped portions 32 is very narrow).

For some embodiments of the present invention, after the SOG film 34 is etched, the portions of the SOG film 34a in the recesses are thermally treated. The portions of the SOG film 34a may be, for example, thermally treated at a temperature of about 400° C. to about 1,200° C. When this heat treatment process for the portions of the SOG film 34a is performed at a temperature of lower than about 400° C., the portions of the SOG film 34a may not be changed into silicon oxide films. On the other hand, when the heat treatment process for the portions of the SOG film 34a is performed at a temperature of higher than about 1,200° C., the stepped portions 32 and the substrate 30 may be damaged.

As a result of the heat treatment for the portions of the SOG film 34a in the recesses, the portions of the SOG film 34a, including polysilazane, may be changed into silicon oxide films having silicon-oxygen (Si—O) bonds. The heat treatment should have no effect on the gap filling capacity of the portion of the SOG film 34a because the portion of the SOG film 34a sufficiently filled in the recess before this thermal treatment.

Referring now to FIG. 3D, an insulation film 36 is formed on the stepped portions 32 and on the portions of the SOG film 34a in the recesses. The insulation film 36 may include oxide formed, for example, using a chemical vapor deposition (CVD) process. In particular embodiments of the present invention, the insulation film 36 includes oxide formed using a plasma enhanced chemical vapor deposition (PECVD) process. The oxide formed using the PECVD process may have a relatively dense structure. In further embodiments of the present invention, the insulation film 36 includes undoped silicate glass (USG), tetraethyl orthosilicate (TEOS), phosphor silicate glass (PSG) or boro-phosphor silicate glass (BPSG).

As shown in FIG. 3D, the insulation film 36 is formed on the stepped portions 32 and on the portions of the SOG film 34a in the recesses. The insulation film 36 may be planarized, for example, using a chemical mechanical polishing (CMP) process. As the insulation film 36 is harder than the portions of the SOG film 34a in the recesses covered by the insulation film 36, the portions of the SOG film 34a may not be damaged during the CMP process to planarize the insulation film 36.

As described above, embodiments of the present invention form a thin film including the insulation film 36 and the portions of the SOG film 34a on the substrate 30 including the stepped portions 32. The thin film includes one portion filling up lower portions of the recesses between the stepped portions of the substrate and another portion evenly formed on the stepped portions of the substrate. For such embodiments where the SOG film 34 is soft baked at a temperature of about 150° C. to about 300° C., the SOG film 34 may not be damaged during the etching process. For conventional methods, because the SOG film is generally hard baked at a temperature of higher than about 400° C., the reflection index and the thickness of the SOG film typically vary with the delay time. Thus, embodiments of the present invention may significantly reduce variation of the reflection index and the thickness of the SOG film 34 because the SOG film 34 is soft baked at a temperature of about 150° C. to about 300° C. The resulting SOG film 34 can have an excellent uniformity that is continuously maintained during the etching process. Furthermore, defects such as a void may not be generated in the thin film including the insulation film 36 and the SOG film 34a because the SOG film generally has a good uniformity.

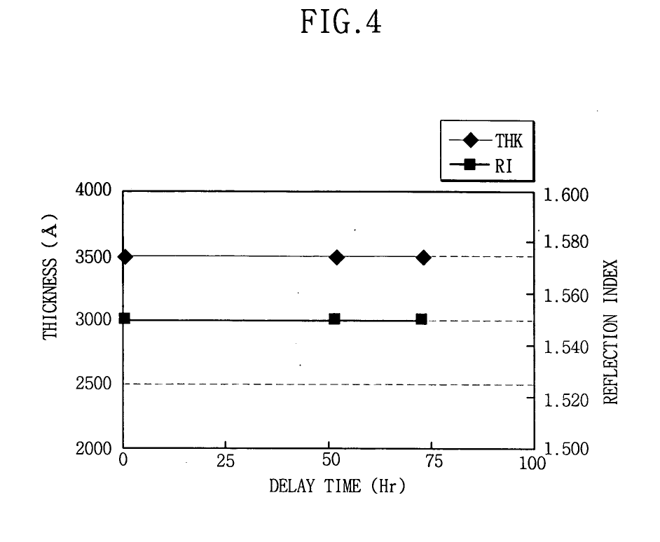

FIG. 4 is a graph illustrating variations of a reflection index and a thickness of an SOG film relative to a delay time according to some embodiments of the present invention. For the embodiments of FIG. 4, the SOG film was soft baked at a temperature of about 150° C.

As shown in FIG. 4, the reflection index (RI) and the thickness (THK) of the SOG film were not substantially varied in accordance with the delay time. Thus, characteristics of the SOG film were not affected by etching the SOG film after the SOG film was soft baked. In other words, while the SOG film was etched using an etching solution including hydrogen fluoride (HF) after the SOG film was soft baked, an etching rate of the SOG film is constantly maintained over the delay time. As the SOG film treated by a soft-baking process can have an excellent uniformity during an etching process, an insulation film may be formed without formation of a failure like a void when the insulation film is on the etched SOG film.

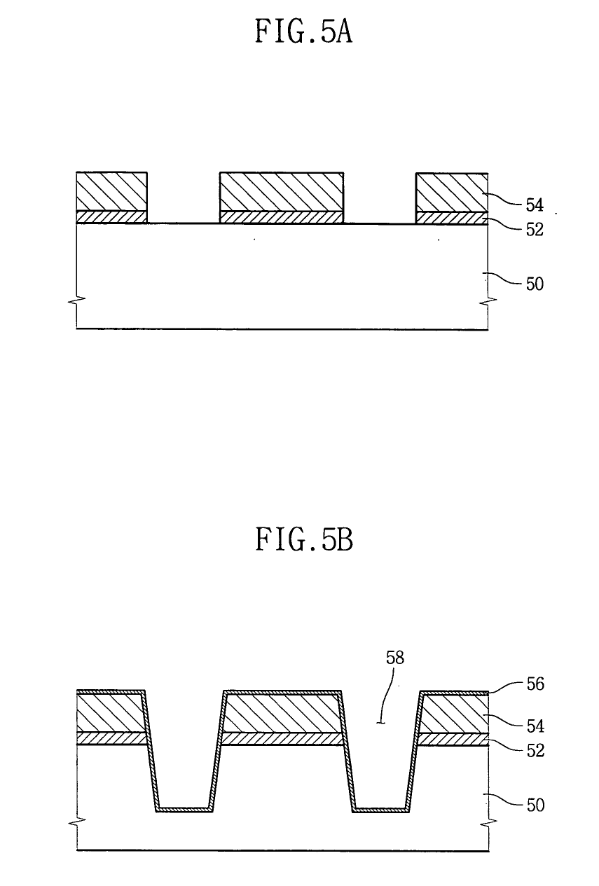

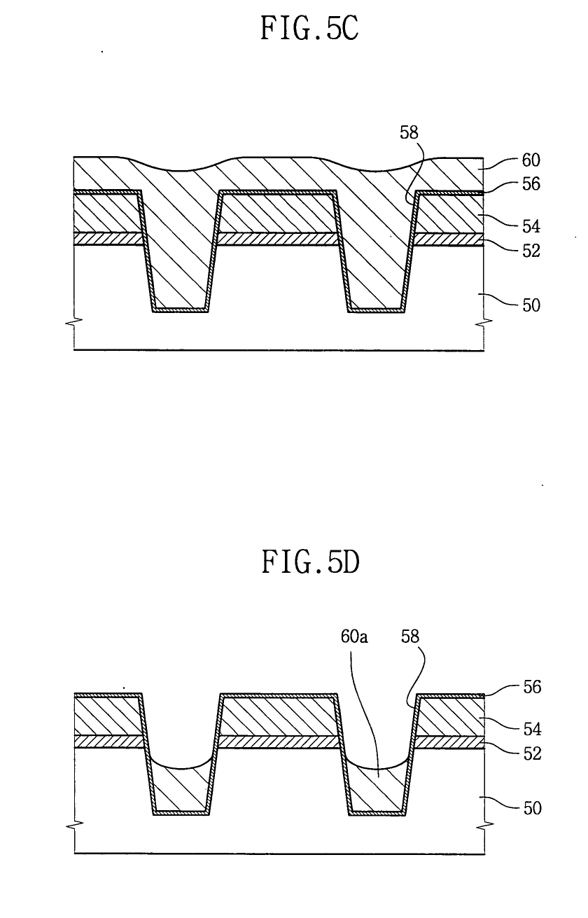

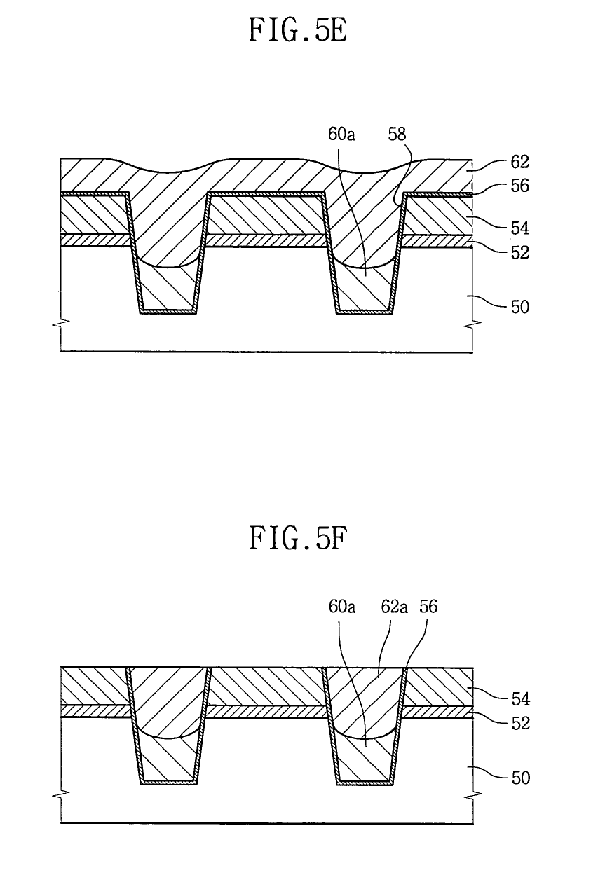

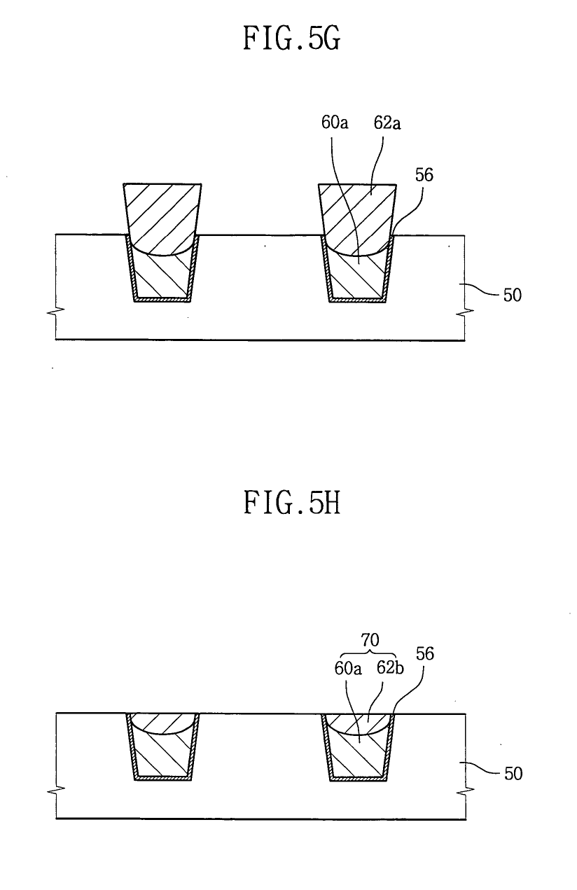

FIGS. 5A to 5H are cross-sectional views illustrating method for forming a trench isolation film according to some embodiments of the present invention.

Referring first to FIG. 5A, a pad oxide film pattern 52 and a hard mask pattern 54 are formed on an integrated circuit substrate 50. More particularly, after a pad oxide film and a hard mask film are successively formed on the substrate 50, a photoresist pattern is formed on the hard mask film. The photoresist film may be formed using a photo process. The pad oxide film and the hard mask film are patterned using the photoresist pattern as an etching mask, thereby forming the pad oxide film pattern 52 and the hard mask pattern 54 on the substrate 50. The photoresist pattern is then removed, for example, using an ashing process and/or a stripping process.

Referring now to FIG. 5B, the substrate 50 is partially etched using the pad oxide film pattern 52 and the hard mask pattern 54 as an etching mask. In other words, a portion of the substrate 50 exposed by the pad oxide film pattern 52 and the hard mask pattern 54 is etched to a predetermined depth. As a result, a trench 58 having the predetermined depth is formed on the substrate 50.

A liner 56 is continuously formed on the substrate 50 including the trench 58. As shown in FIG. 5D, the liner 56 is formed on an upper face of the hard mask pattern 54, on a sidewall of the hard mask pattern 54, on a sidewall of the pad oxide film pattern 52, on a sidewall of the trench 58 and on a bottom face of the trench 58. The liner 56 may, for example, include silicon nitride. In other embodiments of the present invention, the liner 56 is omitted.

As shown in FIG. 5C, an SOG solution, which may include polysilazane, is coated on the resultant structure (FIG. 5B) formed on the substrate 50 such that an SOG film 60 is formed to fill up the trench 58. The SOG film 60 is filled up in the trench 58 and is formed on the liner 56. As a result of the gap filling characteristics of the SOG film 60, the trench 58 may be completely filled with the SOG film 60. In other words, the SOG film 60 may fill up the trench 58 without generating a void.

The formed SOG film 60 is soft baked, for example, at a temperature of about 150° C. to about 300° C., so that the SOG film 60 is hardened. When such a soft baking process is performed on the SOG film 60, the SOG film 60 can have a constant reflection index (RI) and a predetermined thickness (THK) with a delay time as discussed previously. In other words, the RI and the THK of the SOG film 60 may not vary with the delay time. As a result, the SOG film 60 may have a substantially constant etching rate so as to be generally uniformly etched when successive processes, like an etching process and a CMP process, are performed that affect the soft baked SOG film 60.

Referring now to FIG. 5D, the surface of the SOG film 60 in the region of the trench 58 is etched. The etching process for the SOG film 60 may be a wet etching process or a dry etching process. In some embodiments of the present invention, the SOG film 60 is etched by a wet etching process using a hydrogen fluoride solution as an etching solution. During etching of the SOG film 60, the liner 56, where present, may serve as an etch stop film. As a result, the hard mask pattern 54 and the pad oxide film pattern 52 may not be damaged during etching the SOG film 60 as they may be protected by the liner 56.

When etching of the SOG film 60 is completed, a portion of the SOG film 60a remains in the trench 58. As shown in FIG. 5D, the portion of the SOG film 60a has a height lower than the depth of the trench 58. In other words, an upper face of the portion of the SOG film 60a is positioned beneath an upper portion of the trench 58. When the SOG film 60 is soft baked, the portion of the SOG film 60a may have a good uniformity after the SOG film 60 is etched because of characteristics of the soft baked SOG film 60 as discussed with reference to the embodiments of FIGS. 3A to 3D.

After the SOG film 60 is etched, the substrate 50 including the portion of the SOG film 60a may be thermally treated. Such a heat treatment process for the substrate 50 may be at a temperature of about 400° C. to about 1,200° C. Such a heat treatment process may change the portion of the SOG film 60a into a silicon oxide film.

As shown in FIG. 5E, an insulation film 62 is formed on the substrate 50 including the resultant structure of FIG. 5D. The insulation film 62 may be formed using, for example, a CVD process. The insulation film 62 may include oxide formed using, for example, a PECVD process. The insulation film 62 may be formed on the portion of the SOG film 60a and on the liner 56.

Referring now to FIG. 5F, the insulation film 62 is planarized using, for example, a CMP process. The insulation film 62 may be polished until the liner 56 and/or the hard mask pattern 54 is exposed. For the embodiments illustrated in FIG. 5F, the insulation film 62 is polished until the hard mask pattern 54 is exposed. Thus, following the CMP process, a portion of the insulation film 62a is formed on the trench 58 above the portion of the SOG film 60a.

As shown in FIG. 5G, the hard mask pattern 54 and the pad oxide film pattern 52 are removed from the substrate 50 using, for example, a wet etching process or a dry etching process. After the hard mask pattern 54 and the pad oxide film pattern 52 are removed, the portion of the SOG film 60a is formed in the trench 58 and the portion of the insulation film 62a is formed on the portion of the SOG film 60a. In other words, the portions of the SOG film 60a and the insulation film 62a may be successively formed in the trench 58.

Referring now to FIG. 5H, the portion of the insulation film 62a is planarized, for example, using a CMP process and/or an etch-back process, to form a trench isolation film 70 in the trench 58. The trench isolation film 70 includes the portion of the SOG film 60a and the portion of the insulation film 62a. The trench isolation film may sufficiently fill up the trench by successively forming the portions of the SOG film and the insulation film in the trench. In some embodiments of the present invention, the trench isolation film can, thereby, be formed without a failure like a void.

According various embodiments of the present invention, an SOG film can have good characteristics from a soft baking process while maintaining the gap filling capacity of the SOG film. As a result, a recess of a substrate caused by a stepped portion may be completely filled with the SOG film and a thin film including the SOG film may have a uniformly even upper face. The reliability of an integrated circuit (semiconductor) device may, as a result, be improved without generating a failure, such as a void.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A method of forming a thin film on an integrated circuit substrate including a stepped portion, the method comprising:
forming a spin on glass (SOG) film on the substrate including the stepped portion to fill a recess defined by the stepped portion;
soft baking the SOG film at a temperature of less than about 400° C.;
etching the soft baked SOG film; and
forming an insulation film on the etched SOG film.

2. The method of claim 1, wherein forming the SOG film comprises forming the SOG film using a SOG solution including polysilazane.

3. The method of claim 1, wherein etching the soft baked SOG film is followed by thermally treating the SOG film at a temperature from about 400° C. to about 1200° C. to convert the etched SOG film to silicon oxide.

4. The method of claim 3, wherein thermally treating the SOG film is performed before forming an insulation film on the etched SOG film.

5. The method of claim 1, wherein etching the soft baked SOG film comprises etching the soft baked film to a height lower than the recess defined by the stepped portion and wherein forming an insulation film includes forming the insulation film on the etched SOG film to a height greater than the recess defined by the stepped portion.

6. The method of claim 5, wherein etching the soft baked SOG film further comprises etching the SOG film to expose a surface of the stepped portion and wherein forming the insulation film further comprises forming the insulation film on the exposed surface of the stepped portion.

7. The method of claim 1, wherein soft baking the SOG film is performed at a temperature from about 100° C. to about 300° C.

8. The method of claim 1, wherein etching the SOG film comprises wet etching the SOG film using a hydrogen fluoride (HF) solution.

9. The method of claim 1, wherein the insulation film includes oxide and wherein forming the insulation film comprises forming the insulation film using a chemical vapor deposition (CVD) process.

10. The method of claim 1, wherein etching the soft baked SOG film is followed by thermally treating the substrate.

11. The method of claim 1, wherein the stepped portion includes a plurality of gate electrodes and metal wiring patterns and/or trenches formed on the substrate.

12. The method of claim 1, further comprising planarizing the formed insulation film.

13. The method of claim 12, wherein planarizing the formed insulation film comprises planarizing the formed insulation film using a chemical mechanical polishing (CMP) process.

14. A method of forming a trench isolation film including forming a thin film according to the method of claim 1, wherein the stepped portion comprises a trench on the substrate, the method further comprising removing the formed insulation film to expose the substrate adjacent the trench.

15. A method of forming a trench isolation film on an integrated circuit substrate, the method comprising:
forming a trench on the substrate using a pattern;
forming a spin on glass (SOG) film on the substrate including the formed trench to fill the trench;
soft baking the SOG film at a temperature of less than about 400° C.;
etching the soft baked SOG film;
forming an insulation film on the etched SOG film;
removing a portion of the formed insulation film to expose the pattern;
removing the exposed pattern; and
planarizing a remaining portion of the insulation film.

16. The method of claim 15, wherein forming the SOG film is preceded by forming a liner on a surface of the substrate, a sidewall of the trench and/or a bottom face of the trench.

17. The method of claim 15, wherein etching the soft baked SOG film is followed by thermally treating the etched SOG film at a temperature from about 400° C. to about 1200° C. to convert the etched SOG film to silicon oxide.

18. The method of claim 15, wherein soft baking the SOG film is performed at a temperature from about 100° C. to about 300° C.

19. The method of claim 15, wherein etching the SOG film comprises wet etching the SOG film using a hydrogen fluoride (HF) solution.

20. The method of claim 15, wherein the insulation film includes oxide and wherein forming the insulation film comprises forming the insulation film using a chemical vapor deposition (CVD) process.

21. The method of claim 15, wherein planarizing a remaining portion of the insulation film comprises planarizing the remaining portion of the insulation film using a chemical mechanical polishing (CMP) process.

22. A method of forming a thin film on an integrated circuit substrate, the method comprising:
forming a spin on glass (SOG) film on the substrate;
soft baking the SOG film at a temperature of less than about 400° C.;
etching the soft baked SOG film; and
forming an insulation film on the etched SOG film.

23. A method for forming a thin film comprising:
forming a spin on glass (SOG) film on a substrate including a stepped portion by coating an SOG solution on the stepped portion and on the substrate wherein the SOG film at least partially fills up a recess formed by the stepped portion;
soft baking the SOG film;
etching the SOG film; and
forming an insulation film on a resultant structure formed on the substrate.

24. The method of claim 23, wherein the soft baking the SOG film is performed at a temperature of about 100° C. to about 300° C.

25. The method of claim 23, wherein the SOG film is etched by a wet etching process using a hydrogen fluoride (HF) solution.

26. The method of claim 23, wherein the insulation film includes oxide and the insulation film is formed using a chemical vapor deposition (CVD) process.

27. The method of claim 23, further comprising thermally treating the substrate including the resultant structure.

28. The method of claim 27, wherein the substrate is treated at a temperature of about 400° C. to about 1,200° C.

29. The method of claim 23, wherein the stepped portion includes at least two gate electrodes, at least two metal wiring patterns or trenches formed on the substrate.

30. The method of claim 23, further comprises planarizing the insulation film using a chemical mechanical polishing (CMP) process.

31. A method for forming a trench isolation film comprising:
forming a trench on a substrate by etching the substrate using a pad oxide film pattern and a hard mask pattern as etching masks;
forming an SOG film on a substrate to sufficiently fill up the trench by coating an SOG solution on the substrate including the trench;
soft baking the SOG film;
etching a whole surface of the SOG film;
forming an insulation film on a resultant structure formed on the substrate;
partially removing the insulation film to expose the hard mask pattern;
removing the hard mask pattern and the pad oxide film pattern; and
removing the insulation film remaining on a surface of substrate to expose the surface of the substrate.

32. The method of claim 31, wherein the soft baking the SOG film is performed at a temperature of about 100 to about 300° C.

33. The method of claim 31, wherein the SOG film is etched by a wet etching process using an HF solution.

34. The method of claim 31, wherein the insulation film includes oxide and the insulation film is formed using a CVD process.

35. The method of claim 31, further comprising thermally treating the substrate including the resultant structure at a temperature of about 400 to about 1,200° C.

36. The method of claim 31, wherein removing the insulation film is performed using a CMP process.

37. The method of claim 31, further comprising continuously forming a liner including an insulation material on the surface of the substrate, on a sidewall of the trench and on a bottom face of the trench.
